(19) United States
(12) Patent Application Publication
(10) Pub. No.: US 2005/0016364 A1
(43) Pub. Date: Jan. 27, 2005

(54) Information playback apparatus, information playback method, and computer readable medium therefor

(75) Inventor: Kazuhiro Kamiya, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/892,328

(22) Filed: Jul. 16, 2004

(30) Foreign Application Priority Data
Jul. 24, 2003 (JP) P2003-200899

(51) Int. Cl. A63H 5/00; G04B 13/00; G10H 7/00; G10H 1/02

(52) U.S. Cl. 84/627

(57) ABSTRACT

A music information management section manages playback of musical pieces. To play back a musical piece, MP3 data of the musical piece is read from a musical piece data storage section. A decode section converts the read MP3 data into audio data and outputs the audio data. A musical piece to musical piece control section determines continuity between the preceding and following musical pieces at the decoding time of the MP3 data. When there is continuity, the preceding and following musical pieces are output continuously without placing a space therebetween. When there is no continuity, the preceding and following musical pieces are output placing a space therebetween for playback.

### BACKGROUND OF THE INVENTION

1. Field of the Invention

This invention relates to an information playback apparatus, an information playback method, and a computer readable medium for the information play back. However, use of the invention is not limited to the information playback apparatus, the information playback method, or the computer readable medium therefor.

2. Description of the Related Art

An information playback apparatus is available which adopts an art wherein to play back information compressed according to MP3 (MPEG1 Audio Layer 3) in sequence, the end portion of the current information played back is set based on the time or volume level and if the set condition is satisfied, information following the information being played back is started for eliminating the silent zone between the preceding information and the following information. (For example, refer to JP-A-2003-58192.)

However, in the related art, if the current information being played back and the following information to be played back have no relationship, the current information and the following information are played back continuously with the silent zone eliminated. Thus, for example, if the current information being played back is a graceful classic-tinged number and the following information to be played back is an extremely noisy rockstyle number, a problem of giving an unnatural auditory feeling to the listener occurs.

### SUMMARY OF THE INVENTION

It is an object of the invention to provide with an information playback apparatus for outputting a plurality of pieces of information in sequence, including continuity determination device for determining whether or not there is continuity between one piece of the plurality of pieces of information and the next piece of information output following the one piece of information; and output control device for controlling the output start timing of the next piece of information after completion of output of the one piece of information based on the determination result of the continuity determination device.

It is an another object of the invention to provide with an information playback method of outputting a plurality of pieces of information in sequence, including a continuity determination step of determining whether or not there is continuity between one piece of the plurality of pieces of information and the next piece of information output following the one piece of information; and an output control step of controlling the output start timing of the next piece of information after completion of output of the one piece of information in response to the determination result in the continuity determination step.

It is yet another object of the invention to provide with computer readable medium for causing a computer to execute the method as the above-described method.

### BRIEF DESCRIPTION OF THE DRAWINGS

These and other objects and advantages of this invention will become more fully apparent from the following detailed description taken with the accompanying drawings in which:

FIG. 1 is a block diagram to show the general configuration of an information playback apparatus of the invention;

FIG. 2 is a block diagram to show the detailed configuration of the information playback apparatus of the invention;

FIG. 3 is a block diagram to show the hardware configuration of the information playback apparatus according to the invention;

FIG. 4 is a flowchart to show determination processing of continuity between musical pieces;

FIG. 5 is a drawing to show sample waveforms applied when there is continuity between musical pieces;

FIG. 6 is a drawing to show sample waveforms applied when there is no continuity between musical pieces;

FIG. 7 is a drawing to show sample waveforms applied when the preceding and following musical pieces are each complete;

FIG. 8 is a drawing to show the volume levels of the preceding and following musical pieces;

FIG. 9 is a drawing to show a state in which the space between the preceding and following musical pieces is eliminated; and

FIG. 10 is a drawing to show a state in which a silent zone is formed between the preceding and following musical pieces.

### DESCRIPTION OF THE PREFERRED EMBODIMENTS

Referring now to the accompanying drawings, there is shown a preferred embodiment of an information playback apparatus, an information playback method, and an information playback computer readable medium according to the invention. It is assumed that information played back in the embodiment described below is compressed audio data (MP3 data) provided according to MP3 (MPEG1 Audio Layer 3).

In the invention, for example, whether a plurality of musical pieces need to be played back continuously like a medley or live performance or need not continuously be played back as they differ in tune and are separate like a classic-tinged number and a rockstyle number is determined and output of musical pieces is controlled so as not to give an unnatural auditory feeling to the listener. Specifically, a plurality of musical pieces similar in tune are output continuously without forming a silent zone (time interval) between the musical pieces and a plurality of musical pieces not similar in tune are played back at a predetermined time interval (forming a silent zone) between the musical pieces.

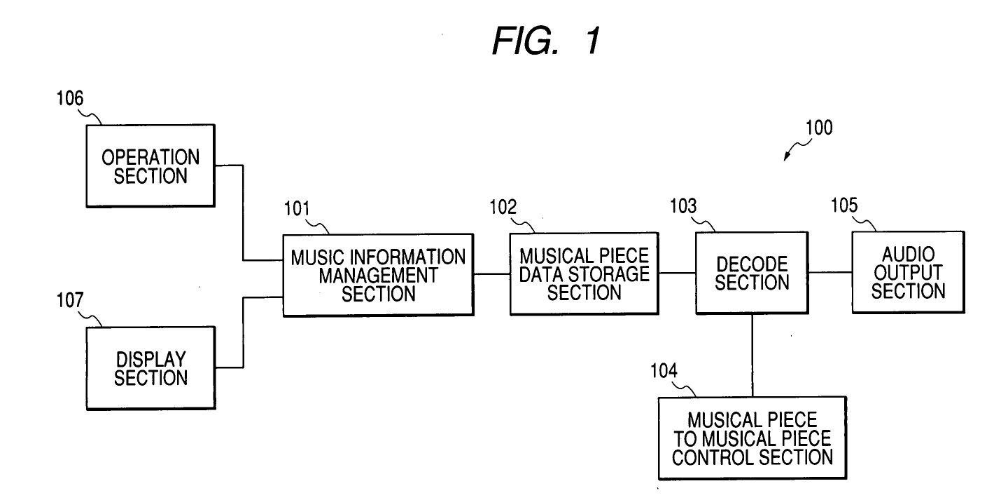

FIG. 1 is a block diagram to show the general configuration of an information playback apparatus 100 in one embodiment of the invention. The information playback apparatus 100 is made up of a music information management section 101 for managing various pieces of information concerning musical pieces and controlling playback of musical pieces, a musical piece data storage section 102 for storing, for example, MP3 data put into files each for one musical piece (MP3 data put into a file will be hereinafter referred to as MP3 file) and opening the MP3 file and reading the MP3 data at the playback time, a decode section 103 for converting the MP3 data read from the musical piece data storage section 102 into audio data and controlling the output timing of the provided audio data, a musical piece to musical piece control section 104 for determining the continuity between pieces of audio data provided by the decode section 103, an audio output section 105 for converting the audio data output in response to the determination of the musical piece to musical piece control section 104 into audio for output as audio, an operation section 106 for the user to operate the music information management section 101, and a display section 107 for displaying at least some of various pieces of the information in the music information management section 101. The various pieces of information described above are implemented as content information concerning the MP3 data as musical pieces. The information in the invention corresponds to the MP3 data as musical pieces in the embodiment.

The information playback apparatus 100 shown in FIG. 1 is implemented by executing hardware of a PC (personal computer) and software installed in the PC for playing back digital music. It is not limited to a PC and can also be implemented as one function provided in an acoustic apparatus, such as a DVD player or an HDD (hard disk drive) recorder, or a portable player capable of playing back MP3 data, for example.

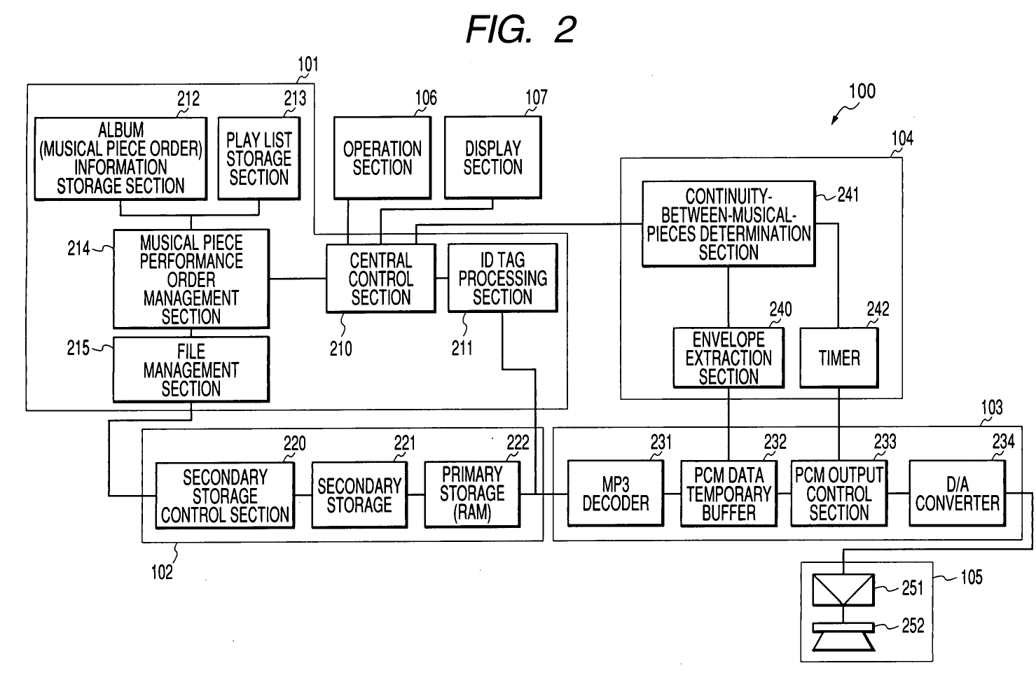

FIG. 2 is a block diagram to show the detailed configuration of the information playback apparatus 100. It shows the detailed configuration of the components shown in FIG. 1. The music information management section 101 includes a central control section 210, an ID tag processing section 211, an album information storage section 212, a play list storage section 213, a musical piece performance order management section 214, and a file management section 215. The central control section 210 has an MMI (man-machine interface) function and the operation section 106 and the display section 107 are connected to the central control section 210 for controlling the operation of the whole apparatus. The central control section 210 detects user's operation of the operation section 106 and manages performance start of a musical piece and various pieces of information concerning musical pieces. It also displays playback elapsed time information of a musical piece, the track number during playback, and the like on the display section 107. When a musical piece is played back, if the MP3 data of the musical piece contains content information of an ID tag, etc., the ID tag processing section 211 extracts the content information and outputs the content information to the central control section 210. The ID tag stores the musical piece title, the album title, the artist name, etc., for example, and the central control section 210 outputs the musical piece title, the album title, the artist name, etc., to the display section 107.

The album information storage section 212 stores album information made up of the album title, the artist name, the basic playback order of the musical pieces contained in the album, the track numbers and playback time of the musical pieces, and the like. The user can operate the operation section 106 to enter the album title and the artist name in the album information storage section 212 in association with each other for each musical piece. In addition, the user can also get the album information in batch through communication device of the Internet, etc., (not shown) for storage in the album information storage section 212. The ID tag processing section 211 and the album information storage section 212 function as content information storage device for storing the content information concerning the musical piece to be played back.

The playback order of musical pieces arbitrarily set by the apparatus user operating the operation section 106, etc., is stored in the play list storage section 213 as a play list. The play list can be set in musical pieces units and the playback order of musical pieces selected out of different albums can be set as desired. The musical piece performance order management section 214 reads the play list stored in the play list storage section 213, manages the order of the musical pieces played back by the apparatus, and sends the order of the musical pieces to be played back to the musical piece data storage section 102.

The file management section 215 controls retrieving the MP3 data corresponding to the musical pieces in the MP3 files according to the order specified by the musical piece performance order management section 214 and reading the MP3 data stored in the MP3 files. The file management section 215 manages execution of a file system of a music playback computer readable medium in the PC.

The musical piece data storage section 102 has a secondary storage control section 220, secondary storage 221, and primary storage 222. The secondary storage 221 is made up of a storage medium such as an HD (hard disk) and a drive such as an HDD for reading data stored on the storage medium, and MP3 data is stored on the storage medium in musical piece units as MP3 files. Since the MP3 data is data compressed to about one tenth as compare with uncompressed data, a larger number of musical pieces can be stored on the storage medium.

The secondary storage control section 220 has a function of read device for controlling read of MP3 data from the secondary storage 221 based on a control command of the file management section 215. If the secondary storage 221 is connected by an ATA interface in the PC, the secondary storage control section 220 controls the ATA interface. When a new musical piece is acquired, the secondary storage control section 220 controls write of the MP3 data into the secondary storage 221 in file units although not shown. The primary storage 222 is implemented as memory such as RAM where data can be read and written at high speed as compared with the secondary storage 221, and temporarily stores the MP3 data read from the secondary storage 221.

The decode section 103 is made up of an MP3 decoder 231 for decoding compressed MP3 data into PCM audio data, a PCM data temporary buffer 232 as a data buffer for sending a predetermined data amount of PCM audio data while temporarily storing the predetermined data amount of PCM audio data to prevent data clogging, etc., in sending the provided PCM audio data to a D/A converter 234 at the following stage, a PCM output control section 233 as output control device for sending the PCM audio data temporarily stored in the PCM data temporary buffer 232 based on the timer time described later, and the above-mentioned D/A converter 234 for converting the received digital PCM audio data into analog form and outputs an audio signal.

The musical piece to musical piece control section 104 is made up of an envelop extraction section 240 as envelop extraction device, a continuity-between-musical-pieces determination section 241 as continuity determination device, and a timer 242. The envelope extraction section 240 extracts an audio waveform envelope from the PCM audio data stored in the PCM data temporary buffer 232. In the embodiment, the envelope is extracted for the trailing portion of PCM audio data in the musical piece sent according to the musical piece performance order and the leading portion of PCM audio data in the next musical piece sent following that musical piece. The invention is not limited to it and the envelope can also be extracted for the whole PCM audio data of each musical piece.

The continuity-between-musical-pieces determination section 241 determines continuity between the preceding and following musical pieces based on the similarity between the envelope of the PCM audio data of the musical piece and the envelope of the PCM audio data of the next musical piece extracted by the envelop extraction section 240. The continuity-between-musical-pieces determination section 241 determines whether or not there is continuity between the musical pieces as “continuity” or “no continuity,” and outputs the determination result to the timer 242 and the central control section 210 using identification information “0/1” of a flag, etc. If the determination result of “continuity” is input, the timer 242 sets the timer time so as to output the following musical piece after completion of output of the preceding musical piece without providing a time interval (without forming a silent zone between the musical pieces). On the other hand, if the determination result of “no continuity” is input, the timer 242 sets the timer time so as to output the following musical piece providing a predetermined time interval (forming a silent zone for a predetermined time) after completion of output of the preceding musical piece.

For example, when “continuity” is input, the timer 242 sets the value of the timer time to be output to the PCM output control section 233 to “110” and at this time, the PCM output control section 233 outputs the PCM audio data of the following musical piece to the D/A converter 234 continuously after completion of output of the PCM audio data of the preceding musical piece to the D/A converter 234. On the other hand, when “no continuity” is input, the timer 242 sets the timer time to be output to the PCM output control section 233 to a predetermined time, for example, “five seconds.” At this time, the PCM output control section 233 outputs the PCM audio data of the following musical piece to the D/A converter 234 in five seconds after completion of output of the PCM audio data of the preceding musical piece to the D/A converter 234. The timer time output by the timer 242 when “continuity” is input is a setup value proper to the apparatus or the user can set any desired value through the operation section 106.

The audio output section 105 is made up of an amplifier 251 for amplifying the analog audio signal provided by the D/A converter 234 and an audio converter 252 such as a loudspeaker or a headphone for converting the amplified audio signal into audio.

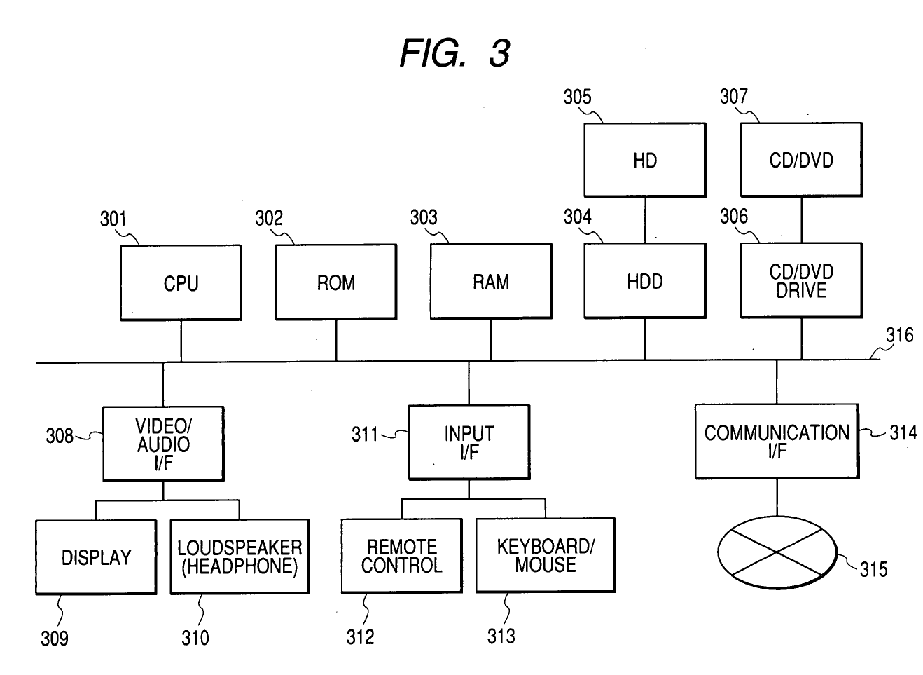

FIG. 3 is a block diagram to show the hardware configuration of the information playback apparatus 100. In FIG. 3, numeral 301 denotes a CPU for controlling the whole apparatus, numeral 302 denotes ROM storing a basic processing program of the information playback apparatus 100, and numeral 303 denotes RAM used as a work area of the CPU 301. Numeral 304 denotes an HDD for reading and writing data from and onto an HD 305 under the control of the CPU 301 and numeral 305 denotes the HD for storing the data written by the HDD 304.

Numeral 306 denotes a CD/DVD drive for reading and writing data from and onto a CD/DVD 307 under the control of the CPU 301 and numeral 307 denotes the CD/DVD storing the data read by the CD/DVD drive 306. A writable disk medium can also be used as the CD/DVD 307. Numeral 308 denotes a video-audio I/F (interface) through which a video display 309 and an audio output loudspeaker (or headphone)310 are connected. A cursor, a menu, a window, or various pieces of data of text, images, etc., are displayed on the display 309, and audio is output from the loudspeaker 310.

Numeral 311 denotes an input I/F through which a remote control 312 including a plurality of keys and a keyboard/mouse 313 for the user to enter characters, digits, commands, etc., are connected. Although not shown, an output I/F is provided as required and a scanner for optically reading characters and images and a printer for printing characters and images can be connected through the output I/F. Numeral 314 denotes a communication I/F connected to a network 315 by radio or through a communication cable for functioning as an interface between the network 315 and the CPU 301. Numeral 316 denotes a bus for connecting the components. The network 315 includes a LAN, a WAN, a public switched network, a mobile telephone network, etc.

The function of the central control section 210 shown in FIG. 2 is provided as the CPU 301 executes programs recorded in the ROM 302, the RAM 303, the HD 305, the CD/DVD 307, and the like in FIG. 3. The functions of the ID tag processing section 211, the musical piece performance order management section 214, the file management section 215, the decode section 103, and the musical piece to musical piece control section 104 shown in FIG. 2 can also be provided as the CPU 301 executes decode program. In addition, the functions of the decode section 103 and the musical piece to musical piece control section 104 can also be provided using a decode dedicated circuit, such as a DSP.

The secondary storage 221 and the primary storage 222 shown in FIG. 2 correspond to the HD 305 and the HDD 304 and the RAM 303 in FIG. 3. The album information storage section 212 and the play list storage section 213 shown in FIG. 2 are implemented using the storage area of the HD 305 shown in FIG. 3.

The function of the operation section 106 shown in FIG. 2 is provided by the remote control 312 or the keyboard/mouse 313 shown in FIG. 3, and the function of the display section 107 shown in FIG. 2 is provided using the display 309 shown in FIG. 3. The function of the audio converter 252 shown in FIG. 2 is provided using the loudspeaker (headphone) 310 shown in FIG. 3.

Next, the operation of the components of the information playback apparatus described above is as follows: The MP3 data of a plurality of musical pieces is previously stored in the secondary storage 221 shown in FIG. 2. Album (musical piece order) information concerning the plurality of musical pieces is stored in the album information storage section 212, and the play list setting the order of the musical pieces to be played back is registered in the play list storage section 213.

The operation section 106 is provided with various buttons. As the user operates the buttons, the apparatus main unit makes a state transition. Upon detection of operation of a PLAY button, the central control section 210 causes the apparatus main unit to make a transition to a PLAY state, and requests the musical piece performance order management section 214 to play back musical pieces.

The musical piece performance order management section 214 references the play list storage section 213 and determines the playback order of the musical pieces in accordance with the musical piece order set in the play list. The playback order is not limited to that conforming to the play list; the musical pieces can be played back in album units stored in the album information storage section 212 and the user can also select any desired musical pieces to play back the musical pieces. In addition, the user can also specify directly the folder name storing the MP3 file or the MP3 file in the secondary storage 221 to play back the musical piece.

The MP3 data of the musical pieces is read from the secondary storage 221 in accordance with the playback order of the musical pieces determined by the musical piece performance order management section 214 as the specified MP3 files are opened by the secondary storage control section 220 under the control of the file management section 215, and the MP3 data is written into the primary storage (RAM) 222. Transfer of data from the secondary storage 221 to the primary storage 222 executed by the secondary storage control section 220 will be discussed. When the data written into the primary storage 222 reaches one amount, transfer of data to the primary storage 222 is temporarily stopped and when the data amount in the primary storage 222 is reduced to one amount, data transfer is again started. This sequence is repeated.

The frame data forming the MP3 data stored in the primary storage 222 is output to the MP3 decoder 231, and the ID tag data is output to the ID tag processing section 211. Information of the name of the music piece to be played back, the album name, the artist name, the playback order, etc., input to the ID tag processing section 211 is displayed on the display section 107 through the central control section 210.

The MP3 decoder 231 decodes the MP3 data into PCM audio data for each frame, and transfers the PCM audio data to the PCM data temporary buffer 232. The PCM data temporary buffer 232 temporarily stores the PCM audio data of the data amount exceeding the time required for envelope extraction executed by the musical piece to musical piece control section 104 and determination processing of continuity between musical pieces executed by the continuity-between-musical-pieces determination section 241. Accordingly, the PCM audio data can be prevented from being output to the D/A converter 234 and from waiting for determination processing of continuity during the determination processing of continuity executed by the continuity-between-musical-pieces determination section 241.

The PCM data temporary buffer 232 outputs the PCM audio data via the PCM output control section 233 to the D/A converter 234 and also outputs the PCM audio data to the envelop extraction section 240. The D/A converter 234 converts the PCM audio data into an analog audio signal and outputs the analog audio signal to the amplifier 251, which then amplifies the analog audio signal. Then, the amplified analog audio signal is converted into audio by the loudspeaker, etc., of the audio converter 252 to produce a sound wave, enabling the user to listen to the musical piece.

Upon completion of read of the MP3 data to the end of the MP3 file, the file management section 215 informs the musical piece performance order management section 214 that read of the MP3 data is complete. Accordingly, the musical piece performance order management section 214 closes the MP3 file storing the read MP3 data and then opens the MP3 file of the next musical piece to be subsequently read and reads the MP3 data; the musical piece performance order management section 214 repeats this sequence. The secondary storage control section 220 appropriately executes transfer control of MP3 data from the secondary storage 221 to the primary storage 222 so that output of PCM audio data of the preceding and following musical pieces is not interrupted in the PCM data temporary buffer 232. The envelope extraction section 240 extracts the envelope of the PCM audio data output from the PCM data temporary buffer 232 and sends the envelope to the continuity-between-musical-pieces determination section 241. The continuity-between-musical-pieces determination section 241 determines continuity between the preceding and following musical pieces based on the envelopes of the PCM audio data of the preceding and following musical pieces extracted by the envelope extraction section 240. The central control section 210 manages the switch timing of the information processed by the ID tag processing section 211 in synchronization with the switch timing of the preceding and following musical pieces detected by the continuity-between-musical-pieces determination section 241.

If the continuity-between-musical-pieces determination section 241 determines that there is “continuity” between the preceding and following musical pieces, the PCM output control section 233 transfers the PCM audio data of the following musical piece to the D/A converter 234 successively after completion of transfer of the PCM audio data of the preceding musical piece to the D/A converter 234. On the other hand, if the continuity-between-musical-pieces determination section 241 determines that there is “no continuity” between the preceding and following musical pieces, the PCM output control section 233 temporarily stops outputting the PCM audio data of the following musical piece to the D/A converter 234 for the time set in the timer 242 after completion of transfer of the PCM audio data of the preceding musical piece to the D/A converter 234. Accordingly, a silent zone for the predetermined time is formed between the preceding and following musical pieces.

While the PCM output control section 233 temporarily stops outputting the PCM audio data to the D/A converter 234, the PCM audio data stored in the PCM data temporary buffer 232 is not consumed (fetched). If the amount of the PCM audio data stored in the PCM data temporary buffer 232 increases to a predetermined data amount as the PCM audio data stored in the PCM data temporary buffer 232 is not consumed, processing of the MP3 decoder 231 is stopped. Since the data amount in the primary storage 222 does not decrease either in association with it, likewise the data transfer from the secondary storage 221 to the primary storage 222 is also temporarily stopped. After this, when the timer time set in the timer 242 is reached, the PCM output control section 233 starts to output the PCM audio data of the following musical piece from the PCM data temporary buffer 232, and the PCM audio data is output from the audio output section 252 as audio.

When output of the PCM audio data to the D/A converter 234 is started, the PCM audio data in the PCM data temporary buffer 232 is consumed and accordingly processing of the MP3 decoder 231 is restarted and data transfer processing between the primary storage 222 and the secondary storage 221 is also restarted. As the processing sequence as described above is performed, determination as to whether or not there is continuity between the preceding and following musical pieces and formation or no formation of a silent zone for a predetermined time in response to the determination as to whether or not there is continuity can be executed.

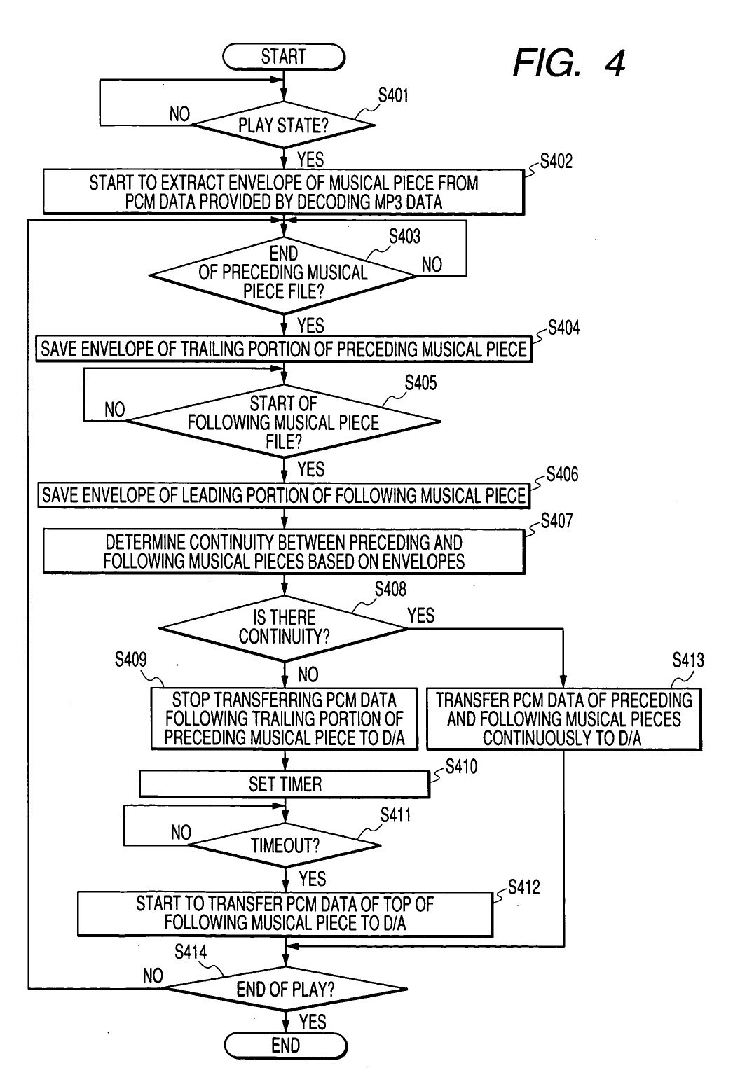

Next, the musical piece to musical piece control during playback of musical pieces according to the described configuration will be discussed. FIG. 4 is a flowchart to show determination processing of continuity between musical pieces. When a musical piece is played back, the apparatus waits for the user to operate the PLAY button provided on the operation section 106 (loop of NO at step S401). Upon detection of operation of the PLAY button (YES at step S401), the apparatus makes a transition to the play state. At the playback time, the MP3 data is read from the secondary storage 221, decode processing of the MP3 decoder 231 is performed, PCM audio data is converted into an analog audio signal by the D/A converter 234, and audio is output, as described above. At the playback time, concurrently the envelope extraction section 240 reads the PCM audio data provided by decoding the MP3 data and starts to extract the envelope of the musical piece (step S402).

After this, whether or not the MP3 data has been read to the end of the MP3 file of the preceding musical piece is determined (step S403). Specifically, while transfer of the MP3 data of the musical piece being played back (the preceding musical piece) from the primary storage 222 to the MP3 decoder 231 continues, the continuity-between-musical-pieces determination section 241 determines that the MP3 data has not yet been read to the end of the MP3 file of the musical piece being played back (NO at step S403); when transfer of the MP3 data is complete, the continuity-between-musical-pieces determination section 241 determines that the MP3 data has been read to the end of the MP3 file of the preceding musical piece (YES at step S403). At this time, the continuity-between-musical-pieces determination section 241 saves the information of the envelope component of the trailing portion of the MP3 data in the MP3 file of the preceding musical piece provided through the MP3 decoder 231, the PCM data temporary buffer 232, and the envelope extraction section 240, for example, the information of the envelope component of the data between the position preceding a predetermined time from the end position of the MP3 data and the end position (step S404).

Subsequently, the apparatus waits for the MP3 file of the next musical piece output following the preceding musical piece to be opened and transfer of the MP3 data to be started (NO at step S405). When transfer of the MP3 data of the following musical piece is started, the continuity-between-musical-pieces determination section 241 detects the following musical piece being started (YES at step S405). At this time, the continuity-between-musical-pieces determination section 241 saves the information of the envelope component of the leading portion of the MP3 data in the MP3 file of the following musical piece provided through the MP3 decoder 231, the PCM data temporary buffer 232, and the envelope extraction section 240, for example, the information of the envelope component of the data to the position advancing a predetermined time from the top position of the MP3 data (step S406).

The continuity-between-musical-pieces determination section 241 determines continuity between the preceding and following musical pieces based on the envelope component of the trailing portion of the preceding musical piece saved at step S404 and the envelope component of the leading portion of the following musical piece saved at step S406 (step S407). The specific processing of the continuity determination will be discussed later.

If the continuity-between-musical-pieces determination section 241 determines that there is “no continuity” as the determination result of continuity between the preceding and following musical pieces (NO at step S408), the PCM output control section 233 stops outputting (transferring) the PCM audio data of the following musical piece to the D/A converter 234 (step S409). The timer 242 functions and the timer time is set (step S410). Transferring the PCM audio data is temporarily stopped for the timer time applied when there is “no continuity” (for example, five seconds mentioned above). The time during which outputting the PCM audio data to the D/A converter 234 is stopped is continued until the timer 242 reaches the timer time (NO at step S411). When the timer 242 reaches the timer time (YES at step S411), the PCM output control section 233 starts to output the PCM audio data from the top of the following musical piece to the D/A converter 234 (step S412).

On the other hand, if it is determined at step S408 that there is “continuity” between the preceding and following musical pieces (YES at step S408), the PCM audio data of the top of the following musical piece is output (transferred) to the D/A converter 234 without providing a time interval continuously with the trailing portion of the PCM audio data of the preceding musical piece (step S413). At this time, the timer time of the timer 242 is set to 0 seconds so as not to place a space between the musical pieces in response to the determination of “continuity.”

As processing at step S412 or S413 terminates, the continuity determination between the preceding and following musical pieces is complete. Then, the end of the musical piece PLAY state is detected. If playback terminates (YES at step S414), the processing is terminated. On the other hand, if playback does not terminate (NO at step S414), the process returns to step S403 and the sequence is repeated. When the musical pieces are played back based on the play list setting a plurality of musical pieces, the determination at step S414 corresponds to the determination at to whether or not the playing back the last musical piece set in the play list terminates. The continuity determination processing terminates just after playing back the last musical piece set in the play list is started because it is to determine the continuity between the last musical piece and the musical piece just preceding the last musical piece.

Next, the determination processing of continuity between the preceding and following musical pieces will be discussed in detail. FIG. 5 is a drawing to show sample waveforms applied when there is continuity between the preceding and following musical pieces. The vertical axis indicates the sound level and the horizontal axis indicates the time. The waveforms shown in the figure are envelope components of audio waveforms of PCM audio data. The left waveform in the figure is a waveform indicating the envelope component of the trailing portion of a preceding musical piece 501 and the right waveform in the figure is a waveform indicating the envelope component of the leading portion of a following musical piece 502. The envelope extraction section 240 includes the configuration of volume level detection device for detecting the volume level of a musical piece.

According to the waveforms shown in FIG. 5, the continuity-between-musical-pieces determination section 241 determines that the volume level of a trailing end 501a of the preceding musical piece 501 is close to the volume level of a leading end 502a of the following musical piece 502. The volume level of an envelope component 501b of the preceding musical piece 501 tends to lessen and likewise the volume level of an envelope component 502b of the following musical piece 502 tends to lessen. Accordingly, since the envelope component of the leading end 502a of the following musical piece 502 can be smoothly concatenated with the trailing end 501a of the preceding musical piece 501, the continuity-between-musical-pieces determination section 241 determines that there is similarity between the envelopes and there is “continuity” between the preceding and following musical pieces. Based on this determination, the PCM output control section 233 concatenates the trailing end 501a of the preceding musical piece 501 (time t1) and the leading end 502a of the following musical piece 502 (time t2) and outputs sound without placing a space between the musical pieces.

The continuity determination can also be made as follows: The progression of the envelope component 501b of the trailing portion of the preceding musical piece 501 is detected over a predetermined time period, the progression of the envelope component 502b of the leading portion of the following musical piece 502 is detected over a predetermined time period, the state of the leading end 502a of the following musical piece 502 that can be concatenated with the state of the trailing end 501a of the preceding musical piece 501 is estimated based on the progressions over the predetermined time period, and the following musical piece 502 matching or almost matching the estimation is determined to have “continuity.” Accordingly, the continuity determination precision can be enhanced.

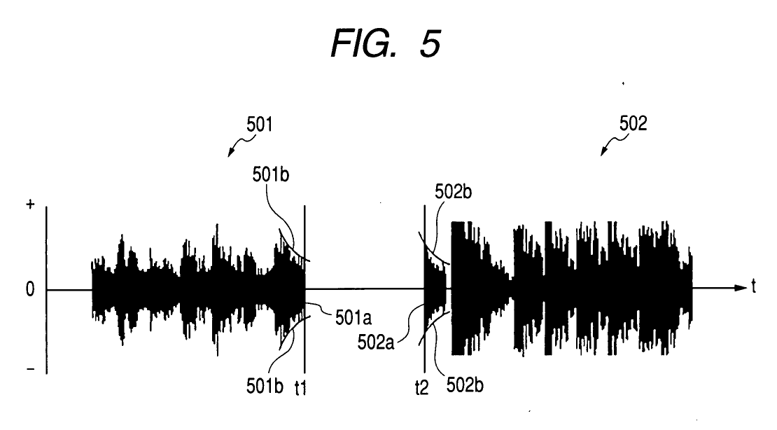

FIG. 6 is a drawing to show sample waveforms applied when there is no continuity between the preceding and following musical pieces. The continuity-between-musical-pieces determination section 241 determines that a preceding musical piece 601 and a following musical piece 602 differ in volume level because the volume level of the following musical piece 602 is close to 0 although the preceding musical piece 601 has a predetermined volume level. The volume level of an envelope component 601b of the preceding musical piece 601 tends to lessen; while the volume level of an envelope component 602b of the following musical piece 602 tends to grow. Accordingly, since the envelope component of the leading end 602a of the following musical piece 602 cannot smoothly be concatenated with the trailing end 601a of the preceding musical piece 601, the continuity-between-musical-pieces determination section 241 determines that there is no similarity between the envelopes and there is “no continuity” between the preceding and following musical pieces. Based on this determination, the PCM output control section 233 does not concatenate the trailing end 601a of the preceding musical piece 601 (time t1) and the leading end 602a of the following musical piece 502 (time t2) and outputs sound placing a space of the timer time corresponding to “no continuity” set in the timer 242 (for example, five seconds) between the preceding musical piece 601 and the following musical piece 602.

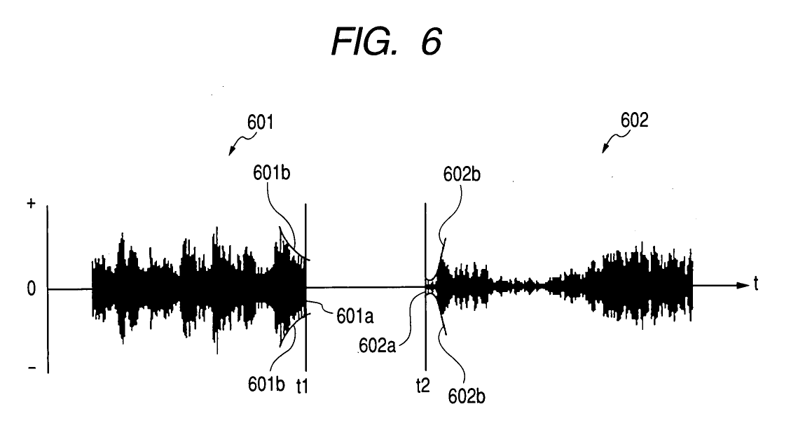

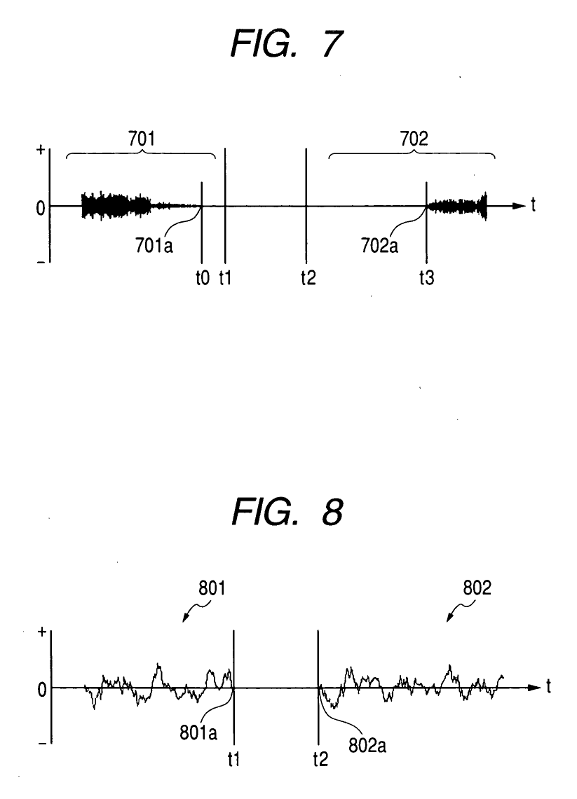

Next, FIG. 7 is a drawing to show sample waveforms applied when the preceding and following musical pieces are each complete. It shows the waveforms of the envelope components of a preceding musical piece 701 and a following musical piece 702. The preceding musical piece 701 has the trailing part as the musical piece to time t1, but a trailing end 701a of audio of the actual musical piece ends at time t0 preceding the time t1. Silence exists between the times t0 and t1. Since the preceding musical piece 701 is a complete musical piece, the volume level gradually drops and finally reaches 0.

The following musical piece 702 has the leading part as the musical piece at time t2, but a leading part 702a of the actual musical piece is time t3 and a silent zone of a short time (for example, about one second) often exists between the times t2 and t3. Thus, as in the example shown in FIG. 7, if a silent zone is formed at the trailing part of the preceding musical piece 701 and a silent zone is formed at the leading part of the following musical piece 702, the continuity-between-musical-pieces determination section 241 determines that there is “no continuity” between the preceding and following musical pieces. In addition, if a silent zone of a predetermined time or more is formed at the trailing part of the preceding musical piece 701 or a silent zone of a predetermined time or more is formed at the leading part of the following musical piece 702, the continuity-between-musical-pieces determination section 241 can also determine that there is “no continuity” between the preceding and following musical pieces.

The silent zone to be formed between musical pieces can also be determined considering the silent zone already formed between the preceding and following musical pieces. In the example shown in FIG. 7, the silent zone is formed between the times t0 and t1 at the trailing part of the preceding musical piece 701 and the silent zone is formed between the times t2 and t3 at the leading part of the following musical piece 702. In such a case, if a silent zone is simply formed as much as the timer time set in the timer 242 between the preceding musical piece 701 and the following musical piece 702, the silent zone between the preceding musical piece 701 and the following musical piece 702 is prolonged additionally as much as the timer time. The silent state may continue over a very long time in some cases, and it is considered that the user assumes by mistake that the end of the musical piece is reached and performs unnecessary operation such as stop operation or is given a feeling of being cumbersome.

Thus, the continuity-between-musical-pieces determination section 241 may detect the silent zone between the preceding musical piece 701 and the following musical piece 702 (times t0 and t1, times t2 and t3) by a timer (not shown), etc., and may control so as not to form a silent zone based on the timer 242 when the silent zone between the times t0 and t3 exceeds the timer time corresponding to “no continuity” set in the timer 242 (for example, five seconds). In this case, the preceding musical piece 701 and the following musical piece 702 between which there is “no continuity” are played back through the already formed silent zone. In addition, when the silent zone between the preceding musical piece 701 and the following musical piece 702 (times t0 and t1, times t2 and t3) exceeds the silent zone corresponding to “no continuity” set in the timer 242, it is also possible that the space between the musical pieces is eliminated so as to match the silent zone corresponding to “no continuity” set in the timer 242.

By the way, FIG. 8 is a drawing to show the volume levels of the preceding and following musical pieces. A preceding musical piece 801 and a following musical piece 802 are indicated each as the audio waveform level. A problem occurring when an attempt is made to determine whether or not there is continuity between the preceding and following musical pieces based simply on the volume level will be discussed. If an attempt is made to determine whether or not there is continuity between the preceding musical piece 801 and the following musical piece 802 based on the audio waveform level, whether or not the audio waveforms of the preceding musical piece 801 and the following musical piece 802 are concatenated with each other is simply determined. If there is no continuity between the preceding and following musical pieces, when both ends of the waveforms of a trailing end 801a of the preceding musical piece 801 and a leading end 802a of the following musical piece 802 are 0 level (zero cross), it may be erroneously determined that there is “continuity.” Therefore, it may be impossible to make a determination as to whether or not there is continuity between the preceding and following musical pieces based only on the audio waveform level. Thus, preferably whether or not there is continuity between the preceding and following musical pieces is determined using the progressions of the envelope components as described above without making a determination based only on the volume level; the volume level is used supplementally.

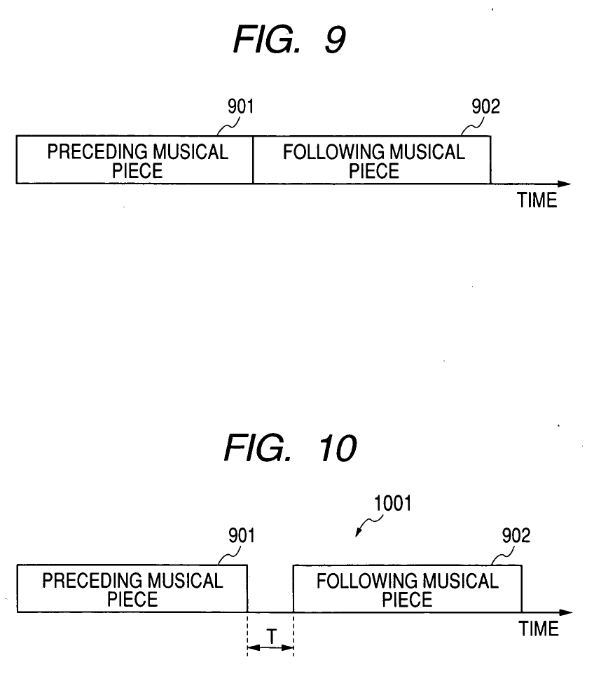

FIG. 9 is a drawing to show a state in which the space between the preceding and following musical pieces is eliminated, and FIG. 10 is a drawing to show a state in which a silent zone is formed between the preceding and following musical pieces. As described above, whether or not there is continuity between the preceding and following musical pieces is determined using the envelope components of the preceding and following musical pieces, whereby when there is “continuity,” output of a preceding musical piece 901 can be followed by output of a following musical piece 902 without placing a space therebetween for playback, as shown in FIG. 9. On the other hand, when there is “no continuity,” a space (silent zone) 1001 corresponding to timer time T set in the timer 242 can be formed between the preceding musical piece 901 and the following musical piece 902 for playback, as shown in FIG. 10.

Thus, whether or not there is continuity between the preceding and following musical pieces is determined, whereby it is made possible to play back the preceding and following musical pieces smoothly and in the optimum concatenation state. For example, for live performance or a medley, the preceding and following musical pieces are originally intended to be continuously played back and the envelope components of the preceding and following musical pieces can be concatenated smoothly, so that it can be determined that there is “continuity” and it is made possible to play back the preceding and following musical pieces continuously without giving an unnatural auditory feeling to the listener.

On the other hand, when the preceding musical piece is a graceful classic-tinged number and the following musical piece is an extremely noisy rockstyle number, the envelope components of the preceding and following musical pieces cannot smoothly be concatenated, so that it can be determined that there is “no continuity” and a silent zone of a predetermined time is formed between the preceding and following musical pieces, whereby the preceding and following musical pieces are not continuously played back and are played back with a space therebetween, so that it is made possible to play back the preceding and following musical pieces without giving an unnatural auditory feeling to the listener although the preceding and following musical pieces differ in genre or tune.

In the determination processing of continuity between the preceding and following musical pieces performed by the continuity-between-musical-pieces determination section 241 described above in the embodiment, the content information of the musical piece to be played back, for example, the content information managed by the ID tag processing section 211 may be used in addition to the method of detecting and using the envelope components of the preceding and following musical pieces. Specifically, when the preceding and following musical pieces are contained in the same album or are played by the same artist, the content information indicating the continuity between the preceding and following musical pieces, such as consecutive track numbers, is used. Accordingly, if whether or not there is continuity between the actual musical pieces cannot be determined in determination as to whether or not there is continuity between the preceding and following musical pieces using the envelope components, it is made possible to determine whether or not there is continuity with accuracy.

For example, when the preceding musical piece ends gently and the following musical piece starts abruptly, if it is determined that there is “no continuity” between the preceding and following musical pieces in the determination of continuity based on the envelopes, when the preceding and following musical pieces are contained in the same album and are assigned consecutive track numbers, the content information can also be used to change the processing so as to concatenate the musical pieces (for example, change the determination as “continuity”). Thus, in addition to use of the envelope components, the content information is used to determine whether or not there is continuity, whereby it is made possible to determine whether or not there is continuity between the preceding and following musical pieces with higher accuracy.

The central control section 210 described above may be provided with a continuity learning function of learning information indicating the presence or absence of continuity input from the continuity-between-musical-pieces determination section 241. Whether or not there is continuity between the preceding and following musical pieces is determined for each musical piece when musical pieces are continuously played back according to the play list. At the termination of playing back the musical pieces set in the play list, the determination as to whether or not there is continuity between the preceding and following musical pieces is complete for all musical pieces. The information indicating the presence or absence of continuity can be output to the musical piece performance order management section 214 and can be stored in the play list storage section 213, etc.

In this case, to later playback the preceding and following musical pieces once learned, the central control section 210 can also read the information indicating the presence or absence of continuity already learned from the play list and output the information to the continuity-between-musical-pieces determination section 241. Accordingly, the continuity-between-musical-pieces determination section 241 can also skip the continuity determination processing described above during playback of the preceding and following musical pieces, whether or not there is continuity between which has already been determined, and output the continuity determination result directly to the timer 242 for controlling the space between the preceding and following musical pieces. At this time, the envelope extraction section 240 can also skip envelope extraction processing.

In the description given above, whether or not there is continuity is determined in one learning, but the invention is not limited to it. Whether or not there is continuity can also be determined based on the results of more than one learning. To conduct more than one learning, whenever a musical piece is played back, the envelope extraction section 240 extracts the envelopes of the preceding and following musical pieces and the continuity-between-musical-pieces determination section 241 determines whether or not there is continuity between the preceding and following musical pieces and then the central control section 210 totally determines whether or not there is continuity between the preceding and following musical pieces based on the determination results as to whether or not there is continuity between the preceding and following musical pieces. As the total determination, for example, when it has been determined that there is “continuity” in all learning times or it has been determined that there is “no continuity” in all learning times, the result is output as the total output. In addition, it is possible to output the result of the determination corresponding to the number of times it has been determined that there is “continuity” or the number of times it has been determined that there is “no continuity,” whichever is the greater, as the total result or it is possible to make total determination when the number of times it has been determined that there is “continuity” or the number of times it has been determined that there is “no continuity” exceeds a predetermined percentage of the total number of times it has been determined (threshold value). At the learning time, the numeric value indicating continuity between the extracted envelopes may be used together.

In the description of the embodiment, it is assumed that the acquired MP3 data is put into files each for one musical piece. The invention is not limited to it. The invention can also be applied to the mode wherein one musical piece is divided into parts at an intermediate point and the divided MP3 data is implemented as one MP3 file. The musical piece dividing can also be applied to the mode wherein only the parts of any desired musical instrument are separated for practice. Although whether or not there is continuity between the preceding and following musical pieces is determined, the continuity determination can also be applied to voice memo, etc.

The embodiment has been described using the MP3 data, but the invention is not limited to it and can also be applied to any other type of compressed audio data such as WMA. It can also be applied to uncompressed audio data. Further, the MP3 files of the musical pieces to be played back are previously stored in the secondary storage 221 such as an HD of a storage medium. However, the invention is not limited to it and can also be applied to streaming playback of content of audio and an image with audio distributed through a network.

As described above, according to the embodiment, to play back the preceding and following musical pieces continuously, whether or not there is continuity between the preceding and following musical pieces is determined using the envelopes of the musical pieces. When there is continuity therebetween, the musical pieces can be played back without providing a time interval; when there is no continuity therebetween, the musical pieces can be output placing a space of a predetermined time between the musical pieces. Therefore, if the contents of the preceding and following musical pieces are unknown, whether or not there is continuity between the preceding and following musical pieces can be determined appropriately, and the information playback apparatus has the advantage that it can provide an environment in which the musical pieces can be played back continuously without giving an unnatural auditory feeling to the listener regardless of whether or not there is continuity between the musical pieces.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. An information playback apparatus comprising:
a continuity determination device for determining whether or not there is continuity between one piece of information among a plurality of pieces of information and next piece of information output following the one piece of information; and
an output control device for controlling an output start timing of the next piece of information after a completion of output of the one piece of information on a basis of the determination result of the continuity determination device.

2. The information playback apparatus according to claim 1, wherein
if the continuity determination device determines that there is continuity, the output control device starts to output the next piece of information continuously without providing a time interval after the completion of output of the one piece of information, and
if the continuity determination device determines that there is no continuity, the output control device starts to output the next piece of information placing a space of a predetermined time after the completion of output of the one piece of information.

3. The information playback apparatus according to claim 1, further comprising:
an envelope extraction device for extracting envelops of the plurality of pieces of information, wherein
the continuity determination device determines whether or not there is continuity between the one piece of information and the next piece of information by comparing the envelope of the one piece of information extracted by the envelope extraction device with the next piece of information with respect to a similarity between the one piece of information and the next piece of information.

4. The information playback apparatus according to claim 3 wherein
the continuity determination device determines whether or not there is continuity between the one piece of information and the next piece of information based on a similarity between an envelope of a trailing portion of the one piece of information and an envelope of a leading portion of the next piece of information.

5. The information playback apparatus according to claim 3, further comprising:
a volume level detection device for detecting a volume level of the one piece of information and a volume level of the next piece of information, wherein
the continuity determination device makes a comparison between the volume level of the one piece of information and the volume level of the next piece of information, detected by the volume level detection device, and
the continuity uses the volume level comparison result as another piece of information to determine whether or not there is continuity between the one piece of information and the next piece of information.

6. The information playback apparatus according to claim 1, further comprising:
a storage medium for storing the plurality of pieces of information;
a play list storage device for storing a play list indicating a predetermined playback order; and
a read device for reading the plurality of pieces of information from the storage medium according to the play list stored in the play list storage device.

7. The information playback apparatus according to claim 1, further comprising:
a content information storage device for storing content information relevant to the information, wherein
the continuity determination device uses the content information as another piece of information to determine whether or not there is continuity between the one piece of information and the next piece of information.

8. The information playback apparatus according to claim 1, further comprising:
a data buffer for temporarily storing the information; and
a timer for setting the predetermined time, wherein
the timer sets the predetermined time in response to a determination result of the continuity determination device, and
the output control device controls the output start timing in response to the predetermined time set in the timer.

9. The information playback apparatus according to claim 1, further comprising:
a determination result storage device for storing the determination result of continuity between the one piece of information and the next piece of information, made by the continuity determination device, wherein
the continuity determination device references the determination result of continuity stored in the determination result storage device when the one piece of information and the next piece of information are output again, and
the continuity determination device uses the determination result as the information to determine whether or not there is continuity between the one piece of information and the next piece of information.

10. An information playback method of outputting a plurality of pieces of information in sequence, comprising the steps of:
determining whether or not there is continuity between one piece of the plurality of pieces of information and a next piece of information output following the one piece of information; and
controlling an output start timing of the next piece of information after completion of output of the one piece of information based on the determination result of the continuity.

11. The information playback method according to claim 10 further comprising the steps of:
extracting envelops of the plurality of pieces of information, wherein
the continuity is determined by comparing between the extracted envelope of the one piece of information and the extracted envelope of the next piece of information.

12. An information playback computer readable medium for causing a computer to execute the method according to claim 10.
